(19) United States
(12) Patent Application Publication
(10) Pub. No.: US 2008/0170061 A1
(43) Pub. Date: Jul. 17, 2008

(54) Display system

(75) Inventors: Chin-Sheng Chueh, Gueishan (TW); Chih-Yu Liu, Gueishan (TW); Po-Wen Wang, Gueishan (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/007,870

(22) Filed: Jan. 16, 2008

(30) Foreign Application Priority Data
Jan. 17, 2007 (TW) 096101688

(51) Int. Cl. G09G 5/00

(52) U.S. Cl. 345/213

(57) ABSTRACT

The invention provides a display system. The display system includes a display unit, a power unit, and a control unit. The display unit includes a panel and a light emitting module. The power unit is used for providing a current to the light emitting module. The control unit is used for providing a data signal to the panel and providing a control signal to the power unit for controlling the current. The data signal is synchronized with the control signal.

### BACKGROUND OF THE INVENTION

1. Field of the Invention

The invention relates to a display system, and more particularly, to a method for controlling a power unit of the display system.

2. Description of the Prior Art

In recent years, with the rapid development of various electronic products, commercial and home multimedia systems, such as a home theater, have become more and more popular. And, the most important hardware of a multimedia system is a display apparatus for displaying images. Therefore, how to improve the quality of display apparatuses is a highly important issue for designers.

Please refer to FIG. 1. FIG. 1 is the block diagram of a typical display system. The display system 10 includes a display unit 11, a power inverter 12, and a micro-processor 13. The display unit 11 gene rally includes a panel 11A and a light emitting module 11B. For example, if the panel 11A is an LCD, the light emitting module 11B can be a cold cathode fluorescent lamp (CCFL) or a light emitting diode (LED) module.

The power inverter 12 is used to provide currents to the lighting emitting module 11B, for example a CCFL. The currents provided by the power inverter 12 can generate high voltages at the two ends of the CCFL and further excites fluorescence powders spread on the interior wall of the CCFL to generate visible light.

As shown in FIG. 1, the micro-processor 13 provides a data signal to the panel 11A. For example, the data signal may include image data which to be displayed on the panel 11A. Further, the micro-processor 13 also provides a control signal to the power inverter 12 to control the current outputted by the power inverter 12, so as to adjust the lightness of the light emitting module 11B.

In the prior art, the power inverter 12 includes an oscillator 12A, and the control signal provided from the micro-processor 13 to the power inverter 12 is usually a direct voltage. Please refer to FIG. 2(A). The oscillator 12A is used to continuously generate a triangle wave shown in FIG. 2(A). In this example, the direct voltage labeled as V_{REF} represents the control signal provided by the micro-processor 13.

FIG. 2(B) and FIG. 3(C) are respectively examples of the current provided to the light emitting module 11B and the data signal provided to the panel 11A. Whenever receiving currents provided by the power inverter 12, the light emitting module 11B can be lighted up and maintained certain lightness for a short period of time. Therefore, the power inverter 12 must periodically provide currents to the light emitting module 11B. As shown in FIG. 2(A) and FIG. 2(B), only when the voltage of the triangle-wave is higher than V_{REF}, the power inverter 12 provides currents to the light emitting module 11B. In this example, if V_{REF} is smaller, the time that the power inverter 12 provides currents will be longer in a regular period (T). Correspondingly, the lightness of the light emitting module 11B will be higher.

The data patterns (1C, 2C, and 3C) shown in FIG. 2(C) may respectively include data corresponding to a picture or a video. From the viewpoint of time domain in the prior art, currents provided to the light emitting module 11B and data signal provided to the panel 11A are independent upon each other. In the other word, there is not any specific relation between the time of the current patterns (1B˜4B) and the time of the data patterns (1C˜3C). However, the independent situation above will cause the problem the so-called ripple in the pictures displayed by the panel 11A.

For example, the front part of the data pattern 1C corresponds to the current pattern 1B, the front part of the data pattern 2C corresponds to the current pattern 2B, and the rear part of the data pattern 2C corresponds to the current pattern 3B. Therefore, the upper part of the image corresponding to the data pattern 1C may be brighter, and the upper and lower parts of the image corresponding to the data pattern 2C are respectively brighter. Because the distributions of brightness in the images differ from each other, viewers may see a horizontal bright line drifting up and down in the images and then feel uncomfortable.

### SUMMARY OF THE INVENTION

To solve the aforementioned problems, the invention provides a display system. According to a preferred embodiment of the invention, the display system includes a display unit, a power unit, and a control unit. The display unit includes a panel and a light emitting module. The power unit is used for providing a current to the light emitting module. The control unit provides a data signal to the panel and a control signal to the power unit for controlling the current. The data signal is synchronized with the control signal.

Because the data signal is provided by the control unit, the control unit masters the timing of the data signal in advance. Therefore, the control unit can provide the power unit with the control signal synchronized with the data signal. Further, the current outputted by the power unit can also be synchronized with the data signal. In this way, the ripple problem can be prevented in the display system according to the invention. Besides, compared to the prior art, the power unit according to the invention does not need to include an oscillator for generating triangle waves. The cost of hardware can accordingly be reduced.

The advantage and spirit of the invention may be understood by the following recitations together with the appended drawings.

### BRIEF DESCRIPTION OF THE APPENDED DRAWINGS

FIG. 1 is the block diagram of a typical display system.

FIG. 2(A)˜FIG. 2(C) are the timing diagram of the triangle-wave of an oscillator, the current, and the data signal according to the prior art.

FIG. 3 is the block diagram of a display system according to a preferred embodiment of the invention.

FIG. 4(A)˜FIG. 4(C), FIG. 5(A)˜FIG. 5(C), and FIG. 6(A)˜FIG. 6(C) are the timing diagrams of the control signals, the synchronous currents, and the data signals according to the invention.

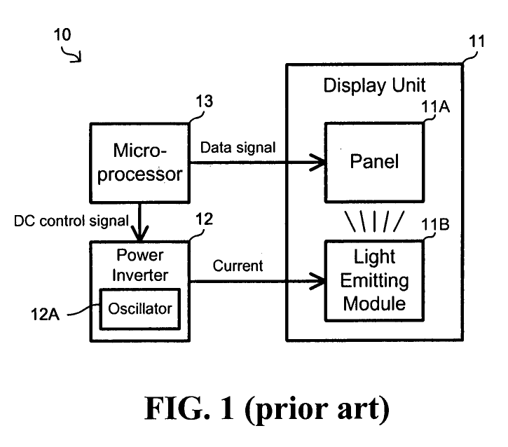

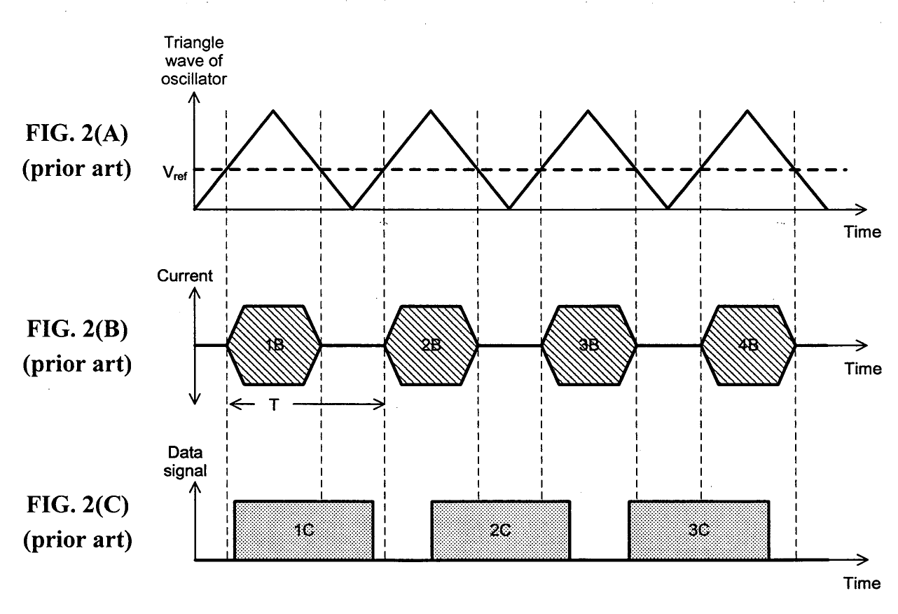

### DETAILED DESCRIPTION OF THE INVENTION

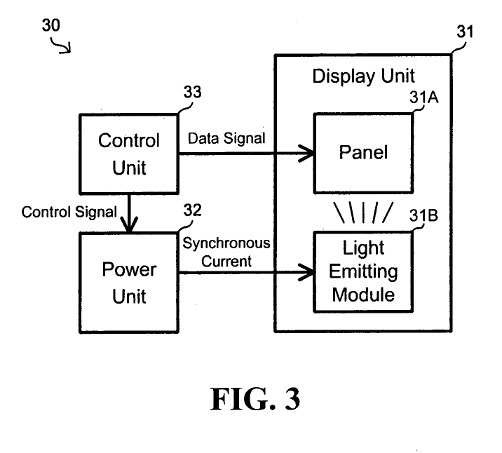

One preferred embodiment according to the invention is a display system. Please refer to FIG. 3, which illustrates the block diagram of the display system 30. The display system 30 includes a display unit 31, a power unit 32, and a control unit 33. The display unit 11 includes a panel 31A and a light emitting module 31B. The power unit 32 provides a synchronous current to the light emitting module 31B. The control unit 33 provides a data signal to the panel 31A and provides a control signal to the power unit 32 for controlling the synchronous current. In actual applications, the panel 31A can be an LCD and the light emitting module 31B can be a CCFL or an LED module.

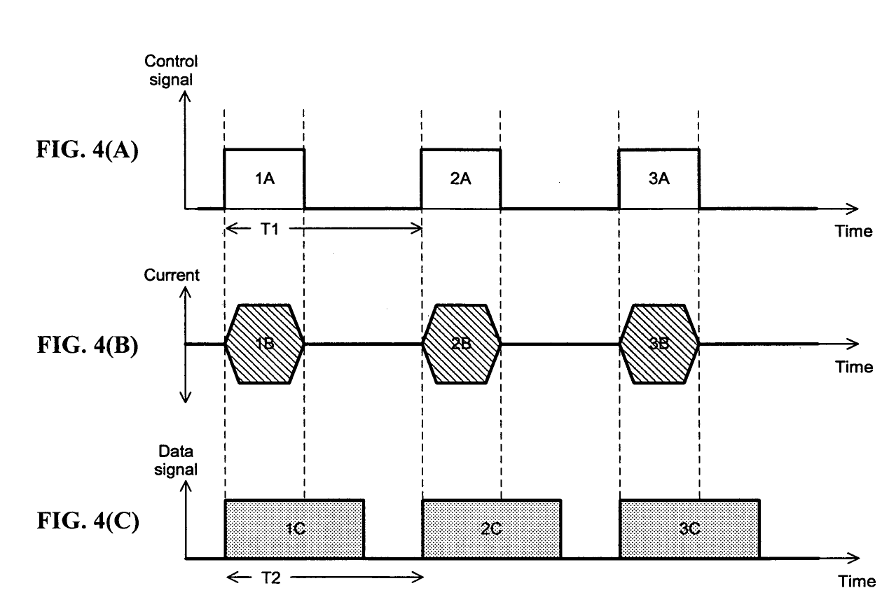

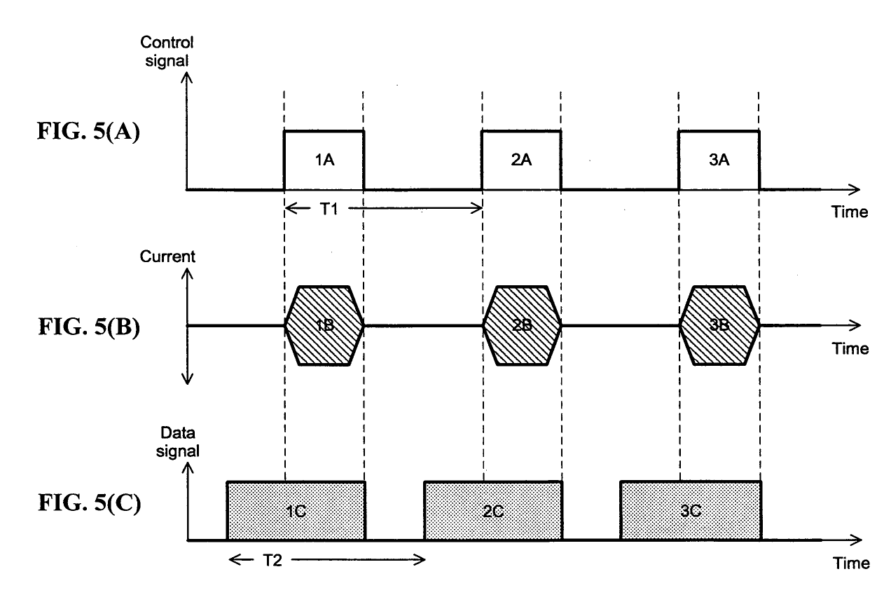

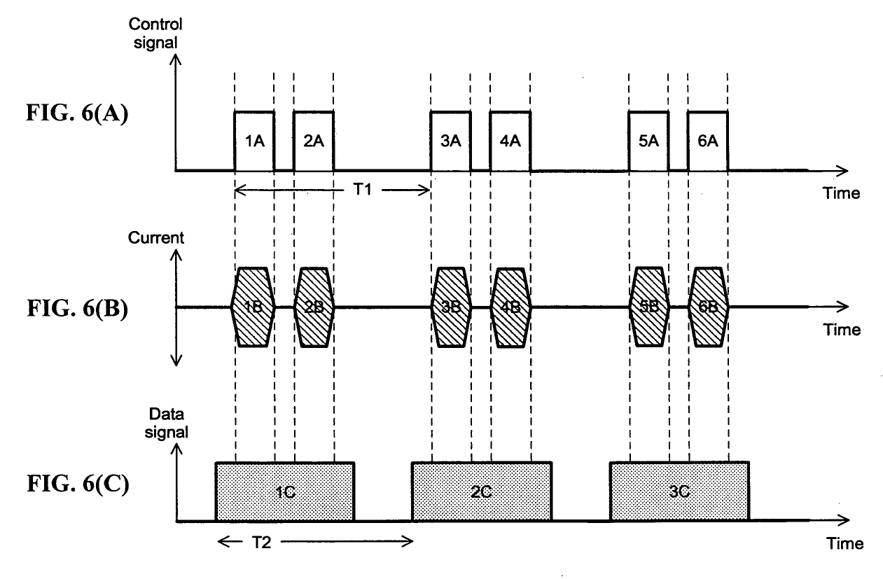

FIG. 4(A)˜FIG. 4(C) are examples of the control signal, the synchronous current, and the data signal according to the invention. The control signal includes a plurality of control patterns (1A˜3A). The synchronous current includes a plurality of current patterns (1B˜3B). The data signal includes a plurality of data patterns (1C˜3C). In this example, the control signal is a pulse width modulation (PWM) signal. The wider the control pattern is, the wider the current pattern is. Namely, the time that the power unit 32 provides the synchronous current is longer.

According to the invention, the data signal is synchronized with the control signal. In the example shown in FIG. 4, the front edges of the control patterns 1A˜3A substantially and respectively aligns with the front edges of the data patterns 1C˜3C. Therefore, the current patterns 1B˜3B and the data patterns 1C˜3C have a regular relation in the time domain. Thus, the display system 30 according to the invention can avoid the ripple problem.

In the practical application, the current pattern and the data pattern certainly can have other aligning relations. FIG. 5(A)˜FIG. 5(C) illustrate another example of the control signal, the synchronous current, and the data signal according to the invention. In this example, the rear edges of the control patterns 1A˜3A substantially and respectively aligns with the rear edges of the data patterns 1C˜3C.

Further, the control signal provided by the control unit 33 can directly be used to control the widths of the current patterns. Compared with the prior art, the power unit 32 according to the invention does not need to include an oscillator for generating triangle wave. The cost of hardware can accordingly be reduced.

In the above examples, the period of the control pattern (T1) is the same with the period of the data pattern (T2). FIG. 6(A)˜FIG. 6(C) illustrate another example of the control signal, the synchronous current, and the data signal according to the invention. In this example, every data pattern corresponds to not only one control pattern. For example, the data pattern 1C corresponds to the control patterns 1A and 2A. Same as the above two examples, the current patterns 1B˜6B and the data patterns 1C˜3C also have a regular relation in the time domain. If every two control patterns (e.g., 1A and 2A) are regarded as a group of control patterns, the period of the group of control patterns (T1) is the same with the period of data patterns (T2). In practical application, the control unit 33 can also make the front edge of the control pattern 1A or the rear edge of the control pattern 2A in FIG. 6(A) substantially align with the front or rear edge of the data pattern 1C.

As described above, the display system according to the invention can prevent the ripple problem. Therefore, the display system according to the invention provides better image quality compared with the prior art. In addition, the display system according to the invention also can reduce the cost of hardware.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display system, comprising:
a display unit having a panel and a light emitting module;
a power unit for providing a current to the light emitting module; and
a control unit for providing a data signal to the panel and providing a control signal to the power unit for controlling the current, the data signal being synchronized with the control signal.

2. The display system of claim 1, wherein the data signal comprises a plurality of data patterns and the control signal comprises a plurality of control patterns.

3. The display system of claim 2 wherein the data pattern corresponds to a first period, the control pattern corresponds to a second period, and the first period is equal to the second period.

4. The display system of claim 3, wherein a first front edge of the data pattern substantially aligns with a second front edge of the control pattern.

5. The display system of claim 3, wherein a first rear edge of the data pattern substantially aligns with a second rear edge of the control pattern.

6. The display system of claim 2, wherein the data pattern corresponds to a third period, and a group of the control patterns, including at least two of the control patterns, corresponds to the third period.

7. The display system of claim 6, wherein a first front edge of the data pattern substantially aligns with a third front edge of a first control pattern in the group of the control patterns.

8. The display system of claim 6, wherein a first rear edge of the data pattern substantially aligns with a third rear edge of a last control pattern in the group of the control patterns.

9. The display system of claim 1, wherein the data signal and the control signal are pulse width modulation (PWM) signals.

10. The display system of claim 1, wherein the display unit is a LCD panel.

11. The display system of claim 1, wherein the light emitting module is a cold cathode fluorescent lamp (CCFL).
